(19) United States
(12) Patent Application Publication
(10) Pub. No.: US 2009/0083748 A1
(43) Pub. Date: Mar. 26, 2009

(54) PROGRAM EXECUTION DEVICE

(76) Inventors: Masakazu KANDA, Kyoto (JP); Go MAKINO, Osaka (JP); Kunihiko HAYASHI, Osaka (JP); Yoshihiro KOGA, Osaka (JP)

Correspondence Address: MCDERMOTT WILL & EMERY LLP, 600 13TH STREET, NW, WASHINGTON, DC, 20005-3096, US

(21) Appl. No.: 12/212,168

(22) Filed: Sep. 17, 2008

(30) Foreign Application Priority Data
Sep. 20, 2007 (JP) 2007-243719

(51) Int. Cl. G06F 9/50

(52) U.S. Cl. 718/104

(57) ABSTRACT

A resource information acquiring unit acquires processor resource information from outside. A program associating unit associates the processor resource information with a program. A processor resource allocating unit allocates processor resources to the program in accordance with the processor resource information when the program is executed.

### BACKGROUND OF THE INVENTION

1. Field of the Invention

The present invention relates to a technology for a program execution device, such as OS (Operating System), which allocates a program to a processor, and then activates and executes the allocated program.

2. Description of the Related Art

The main functions of an OS are hardware management, execution program management, data management, and input/output management. Of the functions, the execution program management manages the execution order of programs, and is an important function for efficiently operating a CPU, a memory, an input/output device, and the like.

One of algorithms for deciding a program execution order is the round robin scheduling. In the round robin scheduling, an arbitrary execution time is allocated to a program, and then, an execution right of a processor is transferred to the program during the allocated execution time, and the execution right is then transferred to another program when the allocated execution time has passed. Accordingly, all of the programs can equally have the execution right within a predetermined duration.

In a real time system wherein media are processed by a processor, it is necessary to execute a plurality of processes, such as encoding, decoding, and multiplexing, at the same time. Therefore, the round robin schedule is applied such that the programs are split for each process so that its process performance can be guaranteed, and processor resources are allocated for each process.

In the case where the forgoing technology is realized in a multi-processor configuration, it becomes important to decide to which processor each program should be allocated. In a symmetric multiple processor (SMP) configuration, programs are dynamically allocated to a plurality of processors at the time of the scheduling so that a system load is divided by the respective processors, which makes it difficult to allocate the execution time to each of the programs. Therefore, in the case where programs are allocated for each processor, it is necessary to select and fix processors. In order to respond to the need, a method was disclosed wherein programs are operated by only a particular processor in a conventional program execution device. An example of the technology is recited in H08-272757 of the Japanese Patent Applications Laid-Open.

In the conventional program execution device, however, only the processor which operates the program can be determined, and it is not possible to allocate other processor resources such as performance and cache as required. As a result, the processing performance cannot be guaranteed when the program is processed, which makes it difficult to design the real time system.

### SUMMARY OF THE INVENTION

Therefore, a main object of the present invention is to provide a program execution device capable of guaranteeing program processing performance and having flexibility in program design.

A program execution device according to the present invention comprises:
a resource information acquiring unit for acquiring processor resource information from outside;
a program associating unit for associating the processor resource information with a program; and
a processor resource allocating unit for allocating processor resources to the program in accordance with the processor resource information when the program is executed. The processor resource information is information, in which information relating to the guarantee of performance, such as operation processor information, performance information and cache information, are aggregated.

According to the present invention, program processing performance is associated with the program as processor resource information, and the processor resources are allocated to the program in accordance with the associated processor resource information. Therefore, the program processing performance can be guaranteed. Further, the flexibility of program design can be assured because the program processing performance can be changed when the processor resource information retained outside is simply changed.

The program execution device according to the present invention may be adapted such that the resource information acquiring unit acquires operation processor information from the processor resource information, and the processor resource allocating unit allocates a processor corresponding to a processor number to the program in the case where the processor number is recited in the operation processor information acquired by the resource information acquiring unit. Here, the operation processor information means information for determining which of the processors executes the program.

Accordingly, the operation processor is allocated to the program in accordance with the operation processor number included in the processor resource information. As a result, the processor which operates the program can be guaranteed.

The program execution device according to the present invention may be adapted such that the resource information acquiring unit acquires operation processor information from the processor resource information, and the processor resource allocating unit allocates an arbitrary processor equally to a plurality of the programs in the case where first instruction information is recited in the operation processor information acquired by the resource information acquiring unit. Here, the first instruction information means information including the instruction to reduce the number of the operating programs.

According to the constitution, wherein one processor is allocated equally to the respective programs, the other processors which are not allocated to any program are halted. As a result, power consumption can be reduced.

The program execution device according to the present invention may be adapted such that the resource information acquiring unit acquires operation processor information from the processor resource information, and the processor resource allocating unit allocates a plurality of processors to a plurality of the programs in a distributed manner in the case where second instruction information is recited in the operation processor information acquired by the resource information acquiring unit. Here, the second instruction information means information including the instruction to equally operate the respective programs.

According to the constitution, wherein the plurality of processors, which correspond to the processor resource information, are allocated to the respective programs in a distributed manner, an operation frequency is reduced in the respective processors. As a result, power consumption can be reduced.

The program execution device according to the present invention may be adapted such that the resource information acquiring unit acquires performance information from the processor resource information, and the processor resource allocating unit allocates operation performance conformable to a performance value to the program in the case where the performance value is recited in the performance information acquired by the resource information acquiring unit. Here, the performance information means information indicating a degree of a capacity necessary for an operation frequency of the processor.

According to the constitution, the operation performance is allocated to the program in accordance with the performance value included in the processor resource information. As a result, the program performance can be guaranteed.

The program execution device according to the present invention may be adapted such that the resource information acquiring unit acquires performance information from the processor resource information, and the processor resource allocating unit allocates a performance equally to the plurality of programs in the case where instruction information is recited in the performance information acquired by the resource information acquiring unit. Here, the instruction information means information including the instruction not to particularly designate the performance because real-time processing is not in execution.

Accordingly, the performance can be allocated equally to the respective programs regardless of the performance of the processor.

The program execution device according to the present invention may be adapted such that the resource information acquiring unit acquires cache information from the processor resource information, and the processor resource allocating unit allocates a cache corresponding to a cache size or a cache position to the program in the case where the cache size or the cache position is recited in the cache information acquired by the resource information acquiring unit. Here, the cache information means information indicating what cache size is necessary or which cache is used for the program.

According to the constitution, wherein the cache is allocated to the program in accordance with the cache size or the cache position included in the processor resource information, the cache size or the cache position allocated to the program can be guaranteed.

The program execution device according to the present invention may be adapted such that the resource information acquiring unit acquires cache information from the processor resource information, and the processor resource allocating unit allocates a plurality of caches equally to the plurality of programs in the case where first instruction information is recited in the cache information acquired by the resource information acquiring unit. Here, the first instruction information means information including the instruction not to particularly designate the cache because real-time processing is not in execution.

According to the constitution, the caches can be allocated equally to the respective programs regardless of the caches of the processor, and the caches can be allocated to one program in the absence of any other program.

The program execution device according to the present invention may be adapted such that the resource information acquiring unit acquires cache information from the processor resource information, and the processor resource allocating unit allocates the same cache to the plurality of programs in the case where second instruction information is recited in the cache information acquired by the resource information acquiring unit. Here, the second instruction information means information including the instruction to share the same cache by the plurality of programs.

According to the constitution, the same cache can be allocated to the respective programs regardless of the caches of the processor, and the cache size can be reduced in the case where a programmer can guarantee that the same cache can be used by the plurality of programs.

The program execution device according to the present invention may be adapted such that the resource information acquiring unit acquires performance information and cache information from the processor resource information, and the processor resource allocating unit allocates a plurality of caches to the plurality of programs in proportion to the performance information in the case where third instruction information is recited in the cache information acquired by the resource information acquiring unit. Here, the third instruction information means information including the instruction to calculate the number of the caches to be allocated from the total number of the caches using a performance allocation ratio with respect to the programs.

Accordingly, the caches which are appropriate for the respective programs can be allocated thereto irrespective of the caches of the processor.

The program execution device according to the present invention may further comprises
a resource abnormality detecting portion for detecting abnormality of the processor resource information; and
a detected information output unit for outputting information detected by the resource abnormality detecting portion.

Accordingly, an abnormality in the processor resource information can be detected.

The program execution device further comprising the resource abnormality detecting portion and the detected information output unit may be adapted such that,
the resource information acquiring unit acquires operation processor information from the processor resource information, and
the processor resource allocating unit suspends allocating a processor to the program when the resource abnormality detecting portion detects the fact that an invalid processor number is recited in the operation processor information, and the detected information output unit outputs the detected information.

Accordingly, an abnormality in the operation processor information included in the processor resource information can be detected.

The program execution device further comprising the resource abnormality detecting portion and the detected information output unit may be adapted such that,
the resource information acquiring unit acquires performance information from the processor resource information, and
the processor resource allocating unit suspends allocating performance to the program when the resource abnormality detecting portion detects the fact that an invalid performance value is recited in the performance information, and the detected information output unit outputs the detected information.

Accordingly, an abnormality in the performance information included in the processor resource information can be detected.

The program execution device further comprising the resource abnormality detecting portion and the detected information output unit may be adapted such that,
the resource information acquiring unit acquires cache information from the processor resource information, and
the processor resource allocating unit suspends allocating a cache to the program when the resource abnormality detecting portion detects the fact that an invalid cache size or position is recited in the cache information, and the detected information output unit outputs the detected information.

Accordingly, the abnormality in the cache information included in the processor resource information can be detected.

The program execution device further comprising the resource abnormality detecting portion and the detected information output unit may be adapted such that,
the resource information acquiring unit acquires operation processor information from the processor resource information, and
the processor resource allocating unit allocates a processor corresponding to a valid processor number to the program when the resource abnormality detecting portion detects the fact that an invalid processor number is recited in the operation processor information.

Accordingly, an abnormality of the operation processor included in the processor resource information is detected, and the abnormal setting is corrected, and then, the operation processor can be allocated to the program.

As thus far described, according to the present invention, the program processing performance can be guaranteed and the flexibility in the program design can be assured in the program execution device. More specifically, any burden caused by the reconfiguration of the system can be lessened while a certain level of processing performance is guaranteed for each function.

In the program execution device according to the present invention, a plurality of programs can each have required performance, and the description of a program independent from processor configuration can be realized. The program design capable of assuring processing performance can be facilitated because the processing performance is allocated for each function, and the functions are realized by a plurality of programs, and further, the program can be flexibly designed. The present invention is applicable to a device which processes a plurality of audios and videos at the same time in real time, an environment where such a device is developed, and the like.

### BRIEF DESCRIPTION OF THE DRAWINGS

These and other objects as well as advantages of the invention will become clear by the following description of preferred embodiments of the invention and is specified in the claims attached hereto. A number of benefits not recited in this specification will come to the attention of the skilled in the art upon the implementation of the present invention.

FIG. 1 is a block diagram illustrating constitutions of a program execution device and peripheral devices according to a preferred embodiment 1 of the present invention.

FIG. 2 is a block diagram illustrating an operation of the program execution device according to the preferred embodiment 1 performed in the case where an operation processor number, a performance value, a cache size, or a cache position is designated in a processor resource information.

FIG. 3 is a block diagram illustrating an operation of the program execution device according to the preferred embodiment 1 performed in the case where first instruction information ANY1 is designated in operation processors in the processor resource information.

FIG. 4 is a block diagram illustrating an operation of the program execution device according to the preferred embodiment 1 performed in the case where second instruction information ANY2 is designated in the operation processors in the processor resource information.

FIG. 5 is a block diagram illustrating an operation of the program execution device according to the preferred embodiment 1 performed in the case where instruction information ANY is designated in performance in the processor resource information.

FIG. 6 is a block diagram illustrating an operation of the program execution device according to the preferred embodiment 1 performed in the case where the first instruction information ANY1 is designated in caches in the processor resource information.

FIG. 7 is a block diagram illustrating an operation of the program execution device according to the preferred embodiment 1 performed in the case where the second information ANY2 is designated in the caches in the processor resource information.

FIG. 8 is a block diagram illustrating an operation of the program execution device according to the preferred embodiment 1 performed in the case where third instruction information ANY3 is designated in the caches in the processor resource information.

FIG. 9 is a block diagram illustrating constitutions of a program execution device and peripheral devices according to a preferred embodiment 2 of the present invention.

FIG. 10 is a block diagram illustrating an operation of the program execution device according to the preferred embodiment 2 performed in the case where an abnormal value is designated in the processor resource information.

### DETAILED DESCRIPTION OF THE INVENTION

Hereinafter, preferred embodiments of a program execution device according to the present invention are described in detail referring to the drawings.

### Preferred Embodiment 1

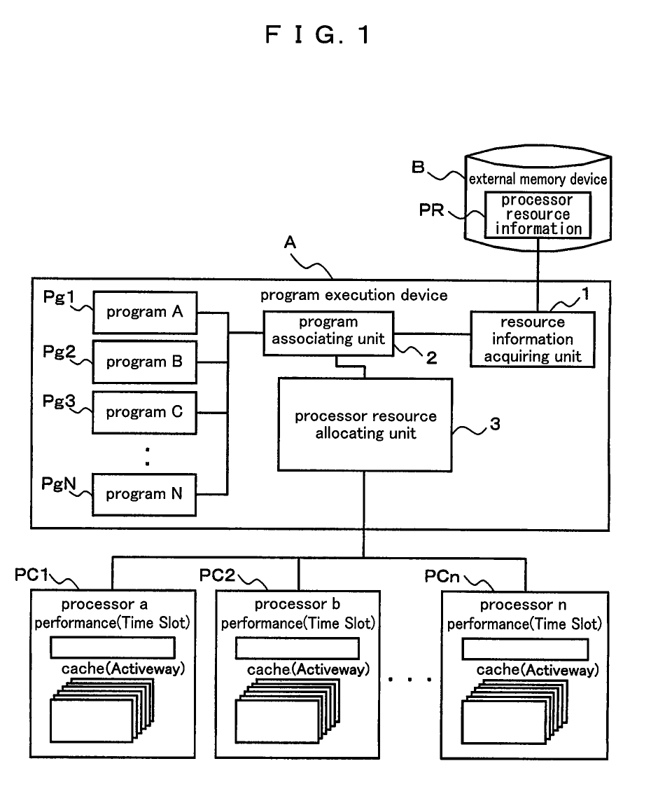

FIG. 1 is a block diagram illustrating constitutions of a program execution device and peripheral devices according to a preferred embodiment 1 of the present invention. In FIG. 1, A denotes a program execution device, B denotes an external memory device, and PC1-PCn denote processors. 1 denotes a resource information acquiring unit, 2 denotes a program associating unit, 3 denotes a processor resource allocating unit, Pg1-PgN denote programs, and PR denotes processor resource information.

The external memory device B is a conventional memory device which retains processor resource information PR, in which information relating to the guarantee of performance such as operation processor information, performance information and cache information are aggregated, in the form of a tabulated list for the programs Pg1-PgN. The operation processor information is information which defines which of the processors executes a program. The performance information is an information indicating a degree of a capacity necessary for an operation frequency of the processor. The cache information is information indicating what cache size is necessary or which cache is used.

The program execution device A comprises a resource information acquiring unit 1 which acquires the processor resource information PR retained in the external memory device, a program associating unit 2 which associates the acquired processor resource information PR with the programs Pg1-PgN, and a processor resource allocating unit 3 which allocates processors PC1-PCn to the programs Pg1-PgN in accordance with the processor resource information PR associated with the programs Pg1-PgN. The processors PC1-PCn are conventional processors provided with performance and caches.

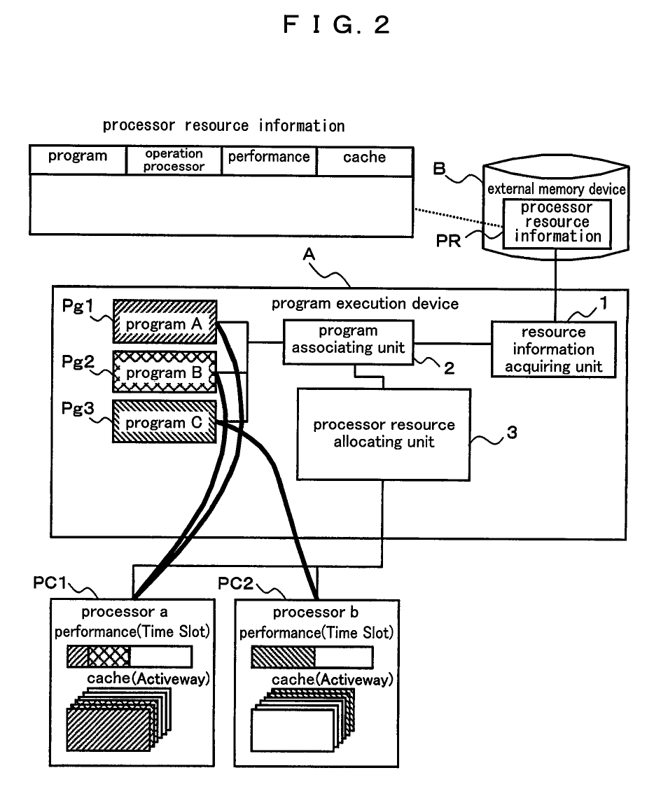

An operation of the program execution device A according to the present preferred embodiment thus constituted is described below. First, operations of the processors which operate the programs Pg1-PgN associated with the processor resource information PR in the case where general values are set in the performance and caches are described referring to FIG. 2. The first program Pg1 acquires the processor resource information PR retained in the external memory device B using the resource information acquiring unit 1. The first program Pg1 associates the processor resource information PR therewith using the program associating unit 2. Further, the first program Pg1 allocates the processor, performance and caches thereto using the processor resource allocating unit 3. The processor corresponds to the operation processor information, performance information and cache information in the processor resource information PR. Accordingly, the first program Pg1 is operated on the first processor PC1 by using the performance and the caches allocated thereto. In a manner similar to the first program Pg1, the second and third program Pg2 and Pg3 are operated on the processors corresponding to the processor resource information PR by using the performance and the caches allocated thereto.

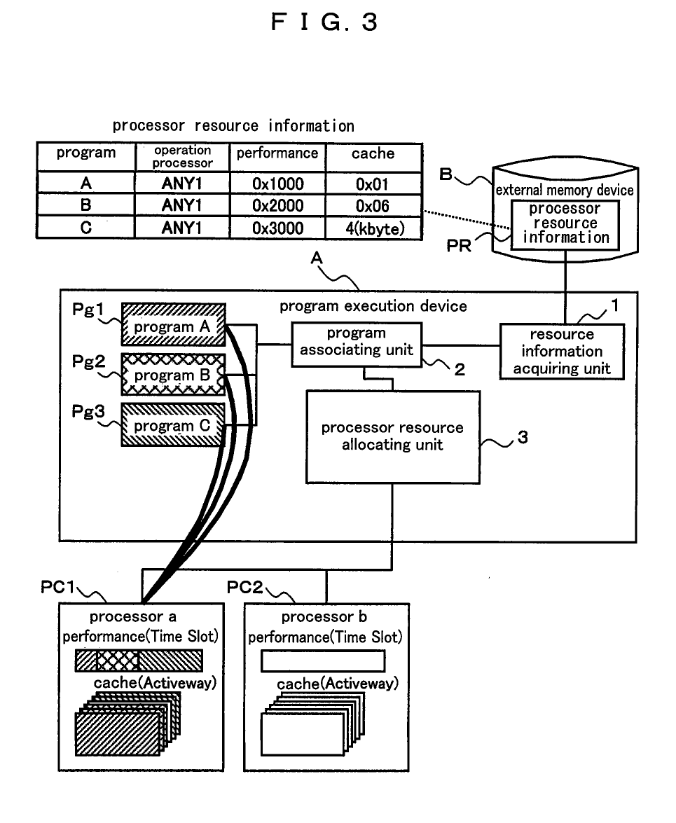

Referring to FIG. 3, an operation in the case where first instruction information ANY1 is set in the processors which operate the programs Pg1-Pg3 associated with the processor resource information PR is described. In the case where the first instruction information ANY1 is set, the first program Pg1 acquires the processor resource information PR retained in the external memory device B using the resource information acquiring unit 1. The program Pg1 associates the processor resource information PR therewith using the program associating unit 2. Further, the first program Pg1 allocates itself to an arbitrary processor (first processor PC1 in FIG. 3) corresponding to the information of the operation processor (ANY1 in FIG. 3) in the processor resource information PR using the processor resource allocating unit 3. Accordingly, the first program Pg1 is operated on the first processor PC1. The second and third programs Pg2 and Pg3 are also allocated to the first processor PC1 in a manner similar to the first program Pg1, and accordingly operated on the first processor PC1. Thus, the programs Pg1-Pg3 are all operated on the first processor PC1.

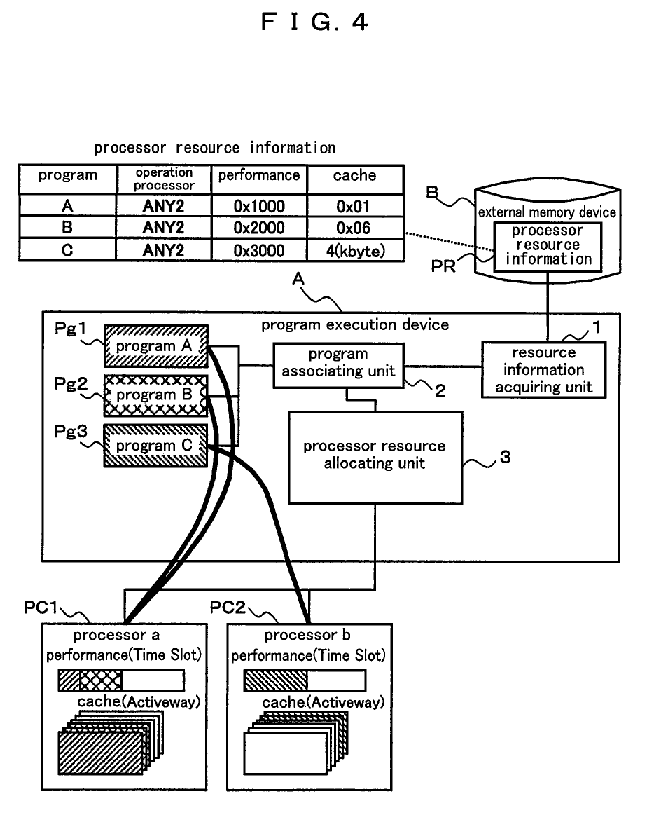

Referring to FIG. 4, an operation in the case where second instruction information ANY2 is set in the processors which operate the programs Pg1-Pg3 associated with the processor resource information PR is described. In the case where the second instruction information ANY2 is set, the first program Pg1 acquires the processor resource information PR retained in the external memory device B using the resource information acquiring unit 1. The program Pg1 associates the processor resource information PR therewith using the program associating unit 2. Further, the first program Pg1 allocates itself to an arbitrary processor (first processor PC1 in FIG. 4) corresponding to the information of the operation processor (ANY2 in FIG. 4) in the processor resource information PR using the processor resource allocating unit 3. Accordingly, the first program Pg1 is operated on the first processor PC1. The second and third programs Pg2 and Pg3 are allocated in a manner similar to the first program Pg1. More specifically, the second program Pg2 is allocated to the first processor PC, and the third program Pg3 is allocated to the second processor PC2. Thus, the programs Pg1-Pg3 are operated on the first processor PC1 and the second processor PC2 in a distributed manner.

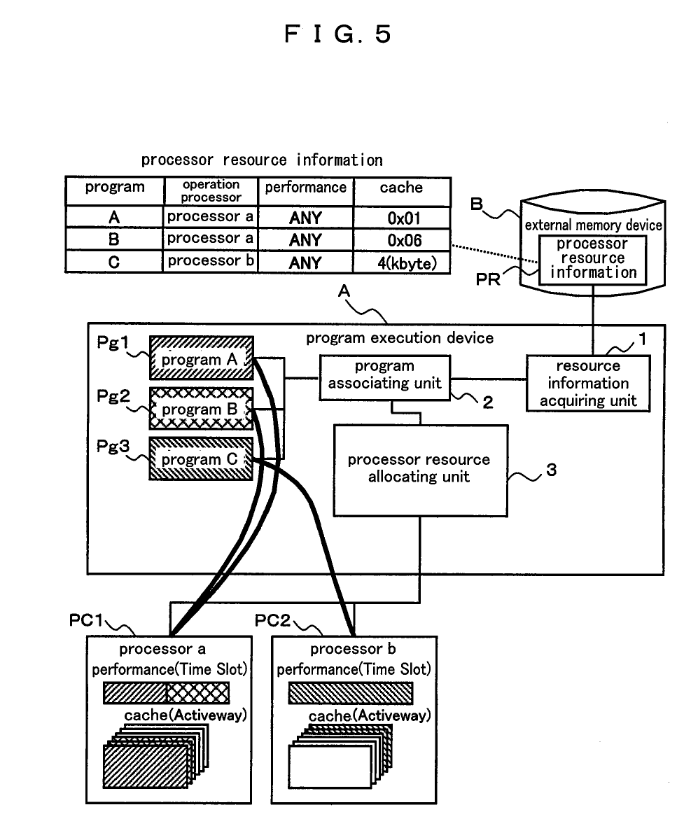

Referring to FIG. 5, an operation in the case where instruction information ANY is set in the performance of the programs Pg1-Pg3 associated with the processor resource information PR is described. In the case where the instruction information ANY is set, each of the programs Pg1-Pg3 acquires the processor resource information PR retained in the external memory device B using the resource information acquiring unit 1. Each of the programs Pg1-Pg3 associates the processor resource information PR therewith using the program associating unit 2. Further, each of the programs Pg1-Pg3 allocates the performance on the first processor PC1 equally to the first and second programs Pg1 and Pg2, and allocate the performance on the second processor PC2 to the third program Pg3 using the processor resource allocating unit 3. Accordingly, the respective programs Pg1-Pg3 are operated.

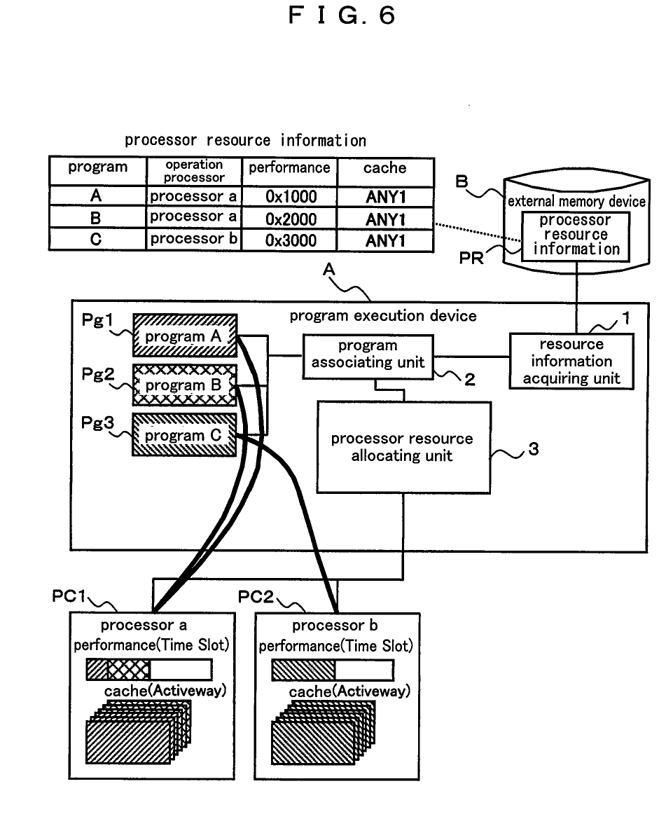

Referring to FIG. 6, an operation in the case where first instruction information ANY1 is set in the caches of the programs Pg1-Pg3 associated with the processor resource information PR is described. In the case where the first instruction information ANY1 is set, each of the programs Pg1-Pg3 acquires the processor resource information PR retained in the external memory device B using the resource information acquiring unit 1. Each of the programs Pg1-Pg3 associates the processor resource information PR therewith using the program associating unit 2. Further, each of the programs Pg1-Pg3 allocates the caches on the first processor PC1 equally to the first and second programs Pg1 and Pg2, and allocates the caches on the second processor PC2 to the third program Pg3, using the processor resource allocating unit 3. Accordingly, the programs Pg1-Pg3 are operated.

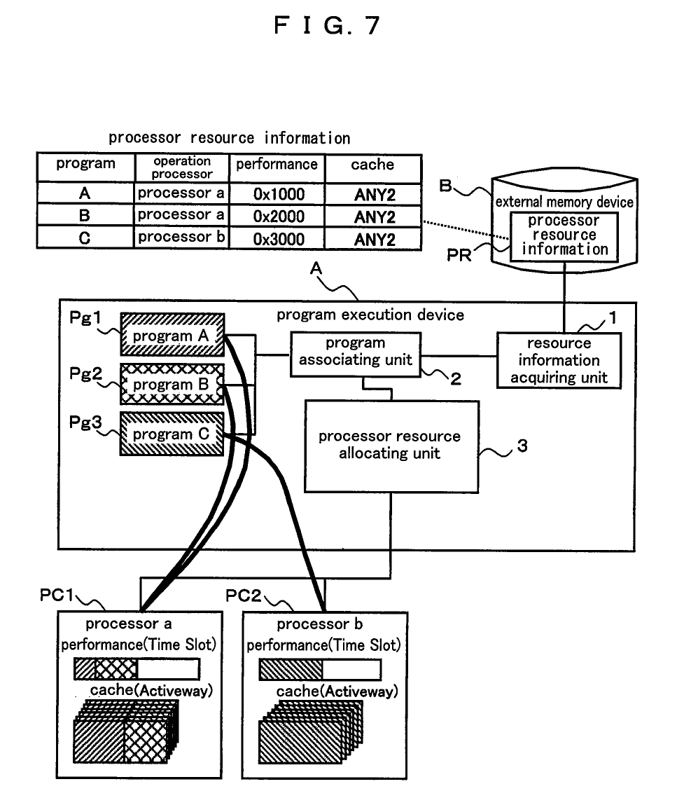

Referring to FIG. 7, an operation in the case where second instruction information ANY2 is set in the caches of the programs Pg1-Pg3 of the processor resource information PR is described. In the case where the second instruction information ANY2 is set, each of the programs Pg1-Pg3 acquires the processor resource information PR retained in the external memory device B using the resource information acquiring unit 1. Each of the programs Pg1-Pg3 associates the processor resource information PR therewith using the program associating unit 2. Further, the programs Pg1-Pg3 allocate the same cache on the first processor PC1 to the first and second programs Pg1 and Pg2, and allocate the caches on the second processor PC2 to the third program Pg3 using the processor resource allocating unit 3. Accordingly, the programs Pg1-Pg3 are operated.

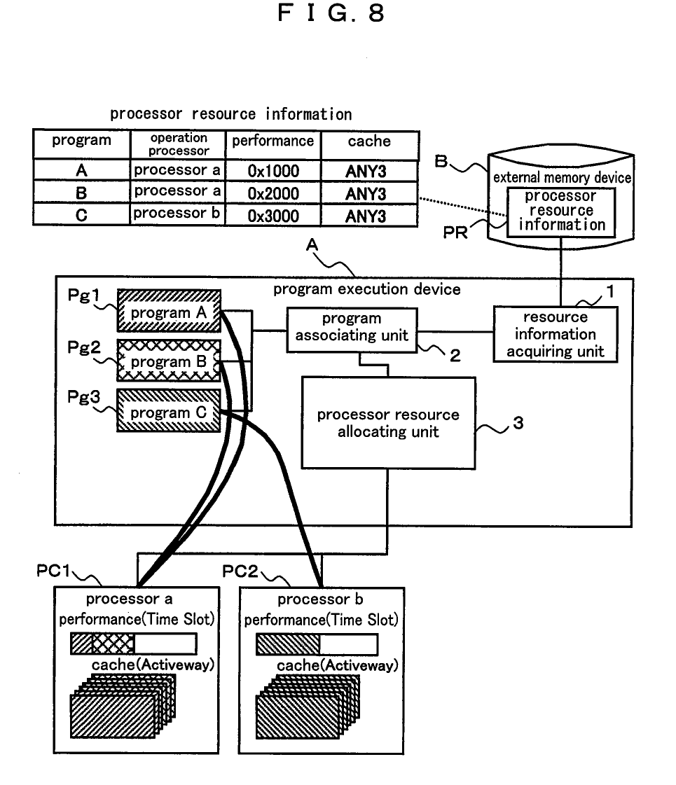

Referring to FIG. 8, an operation in the case where third instruction information ANY3 is set in the caches of the programs Pg1-Pg3 of the processor resource information PR is described. In the case where the third instruction information ANY3 is set, each of the programs Pg1-Pg3 acquires the processor resource information PR retained in the external memory device B using the resource information acquiring unit 1. Each of the programs Pg1-Pg3 associates the processor resource information PR therewith using the program associating unit 2. Further, each of the programs Pg1-Pg3 allocates the caches on the first processor PC1 to the first and second programs Pg1 and Pg2, and allocates the caches on the second processor PC2 to the third program Pg3 using the processor resource allocating unit 3. At the time, the caches on the first processor PC1 are allocated at a ratio in proportion to the performance information in the processor resource information PR. Accordingly, the programs Pg1-Pg3 are operated.

### Preferred Embodiment 2

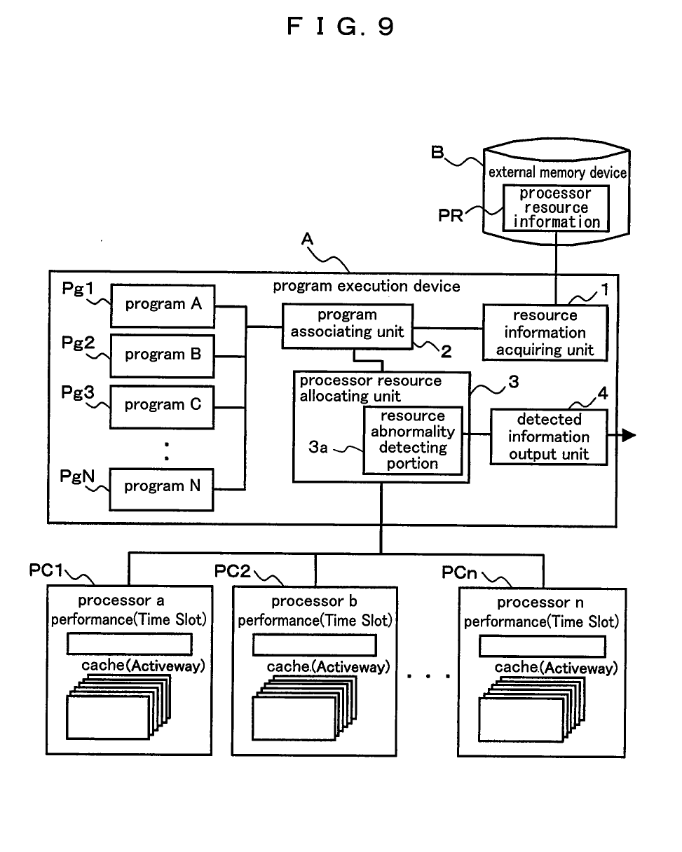

FIG. 9 is a block diagram illustrating constitutions of a program execution device and peripheral devices according to a preferred embodiment 2 of the present invention. In FIG. 9, the same reference symbols as those shown in FIG. 1 according to the preferred embodiment 1 denote the same components. The present preferred embodiment is characterized in that are source abnormality detecting portion 3a and a detected information output unit 4 are further provided. The resource abnormality detecting portion 3a detects abnormality information in the processor resource information PR associated with the programs Pg1-PgN by the program associating unit 2, and is included in the processor resource allocating unit 3. The detected information output unit 4 is provided with a function for outputting outside the information detected by the resource abnormality detecting portion 3a. The description of the rest of the constitution, which is similar to that of the preferred embodiment 1, is omitted.

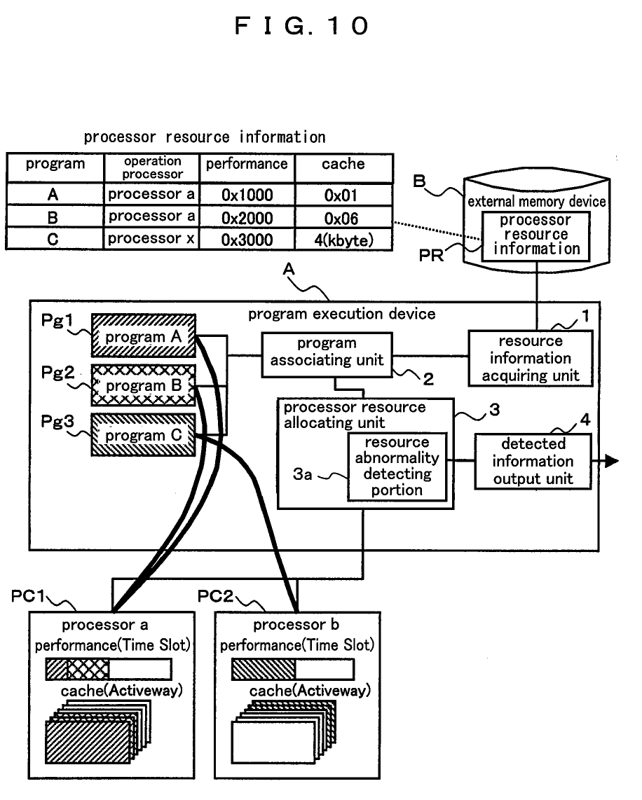

An operation of the program execution device according to the present preferred embodiment thus constituted is described below. Referring to FIG. 10, an operation in the case where an invalid processor number (processor x in FIG. 10) is set in the processor which operates the third program Pg3 in the processor resource information PR is described.

The third program Pg3 acquires the processor resource information PR retained in the external memory device using the resource information acquiring unit 1. Further, the third program Pg3 associates the processor resource information PR therewith using the program associating unit 2.

Then, when the third program Pg3 allocates the processor (corresponding to the operation processor, performance and caches in the processor resource information PR), performance and cache to the first program Pg1 using the processor resource allocating unit 3, the following detection is performed. The resource abnormality detecting portion 3a detects the fact that the processor corresponding to an operation processor number in the processor resource information PR (processor x in FIG. 10) does not exist. As a result of the detection, the third program Pg3 allocates the process or corresponding to an operable processor number (second processor PC2 in FIG. 10) using the processor resource allocating unit 3. Accordingly, the third program Pg3 is operated on the second processor PC2, and the detected information output unit 4 outputs the detected information outside at the same time.

According to the present preferred embodiment, the program processing performance is associated with the program as the processor resource information, and the processor resources are allocated to the program in accordance with the associated processor resource information. Therefore, the program processing performance can be guaranteed, and the program processing performance can be changed when the processor resource information is simply changed. As a result, the program can be flexibly designed.

Next, an operation in the case where an invalid performance value is recited in the performance information in the processor resource information PR acquired by the resource information acquiring unit 1 is described. In this case, because the resource abnormality detecting portion 3a detects the invalid performance value, the processor resource allocating unit 3 suspends the allocation of the performances to the programs, and the detected information output unit 4 outputs the detected information. Accordingly, the abnormality in the performance information in the processor resource information PR can be detected.

Next, an operation in the case where an invalid cache size or position is recited in the cache information in the processor resource information PR acquired by the resource information acquiring unit 1 is described. In this case, because the resource abnormality detecting portion 3a detects the invalid cache size or position, the processor resource allocating unit 3 suspends the allocation of the caches to the programs, and the detected information output unit 4 outputs the detected information. Accordingly, the abnormality in the cache information in the processor resource information PR can be detected.

Next, an operation in the case where an invalid processor number is recited in the operation processor information in the processor resource information PR acquired by the resource information acquiring unit 1. In this case, because the resource abnormality detecting portion 3a detects the invalid processor number, the processor resource allocating unit 3 allocates the processor corresponding to a valid processor number to a program. Accordingly, the abnormality in the operation processor information in the processor resource information PR can be detected, and the operation processor can be allocated after the abnormal setting is corrected.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A program execution device comprising:
a resource information acquiring unit for acquiring processor resource information from outside;
a program associating unit for associating the processor resource information with a program; and
a processor resource allocating unit for allocating processor resources to the program in accordance with the processor resource information when the program is executed.

2. The program execution device as claimed in claim 1, wherein
the resource information acquiring unit acquires operation processor information from the processor resource information, and the processor resource allocating unit allocates a processor corresponding to a processor number to the program in the case where the processor number is recited in the operation processor information acquired by the resource information acquiring unit.

3. The program execution device as claimed in claim 1, wherein
the resource information acquiring unit acquires operation processor information from the processor resource information, and the processor resource allocating unit allocates an arbitrary processor equally to a plurality of the programs in the case where first instruction information is recited in the operation processor information acquired by the resource information acquiring unit.

4. The program execution device as claimed in claim 1, wherein
the resource information acquiring unit acquires operation processor information from the processor resource information, and the processor resource allocating unit allocates a plurality of processors to the plurality of programs in a distributed manner in the case where a second instruction information is recited in the operation processor information acquired by the resource information acquiring unit.

5. The program execution device as claimed in claim 1, wherein
the resource information acquiring unit acquires performance information from the processor resource information, and the processor resource allocating unit allocates operation performance conformable to a performance value to the program in the case where the performance value is recited in the performance information acquired by the resource information acquiring unit.

6. The program execution device as claimed in claim 1, wherein
the resource information acquiring unit acquires a performance information from the processor resource information, and the processor resource allocating unit allocates a performance equally to the plurality of programs in the case where instruction information is recited in the performance information acquired by the resource information acquiring unit.

7. The program execution device as claimed in claim 1, wherein
the resource information acquiring unit acquires cache information from the processor resource information, and the processor resource allocating unit allocates a cache corresponding to a cache size or a cache position to the program in the case where the cache size or the cache position is recited in the cache information acquired by the resource information acquiring unit.

8. The program execution device as claimed in claim 1, wherein
the resource information acquiring unit acquires cache information from the processor resource information, and the processor resource allocating unit allocates a plurality of caches equally to the plurality of programs in the case where first instruction information is recited in the cache information acquired by the resource information acquiring unit.

9. The program execution device as claimed in claim 1, wherein
the resource information acquiring unit acquires cache information from the processor resource information, and the processor resource allocating unit allocates the same cache to the plurality of programs in the case where second instruction information is recited in the cache information acquired by the resource information acquiring unit.

10. The program execution device as claimed in claim 1, wherein
the resource information acquiring unit acquires performance information and cache information from the processor resource information, and the processor resource allocating unit allocates a plurality of caches to the plurality of programs in proportion to the performance information in the case where third instruction information is recited in the cache information acquired by the resource information acquiring unit.

11. The program execution device as claimed in claim 1, further comprising:
a resource abnormality detecting portion for detecting abnormality of the processor resource information; and
a detected information output unit for outputting information detected by the resource abnormality detecting portion.

12. The program execution device as claimed in claim 11, wherein
the resource information acquiring unit acquires operation processor information from the processor resource information, and
the processor resource allocating unit suspends allocating a processor to the program when the resource abnormality detecting portion detects the fact that an invalid processor number is recited in the operation processor information, and the detected information output unit outputs the detected information.

13. The program execution device as claimed in claim 11, wherein
the resource information acquiring unit acquires performance information from the processor resource information, and
the processor resource allocating unit suspends allocating performance to the program when the resource abnormality detecting portion detects the fact that an invalid performance value is recited in the performance information, and the detected information output unit outputs the detected information.

14. The program execution device as claimed in claim 11, wherein
the resource information acquiring unit acquires cache information from the processor resource information, and
the processor resource allocating unit suspends allocating a cache to the program when the resource abnormality detecting portion detects the fact that an invalid cache size or position is recited in the cache information, and the detected information output unit outputs the detected information.

15. The program execution device as claimed in claim 11, wherein
the resource information acquiring unit acquires operation processor information from the processor resource information, and
the processor resource allocating unit allocates a processor corresponding to a valid processor number to the program when the resource abnormality detecting portion detects the fact that an invalid processor number is recited in the operation processor information.
